(19) United States
(12) Patent Application Publication
(10) Pub. No.: US 2015/0070307 A1
(43) Pub. Date: Mar. 12, 2015

(54) APPARATUS FOR PARALLEL READOUT OF TOUCH SCREEN

(71) Applicant: UNIST ACADEMY-INDUSTRY RESEARCH CORPORATION, Ulsan (KR)

(72) Inventors: Franklin BIEN, Ulsan (KR); Hyung Gun Ma, Jinju-si (KR); Sang Hyun Heo, Busan (KR)

(21) Appl. No.: 14/476,880

(22) Filed: Sep. 4, 2014

(30) Foreign Application Priority Data
Sep. 10, 2013 (KR) 10-2013-0108577

(51) Int. Cl. G06F 3/044

(52) U.S. Cl. CPC G06F 3/044
USPC 345/174

(57) ABSTRACT

A touch screen apparatus is provided, including: a plurality of transmission channels to which a plurality of coded signals are input; a touch screen panel configured to convert the plurality of coded signals to a plurality of sensing currents according to a touch input of a user; an amplifier configured to amplify at least one current among the plurality of sensing currents to generate an output voltage; and a current subtraction circuit configured to generate a second current having an opposite phase to that of a first current among the sensing currents in a node where the touch screen panel is connected with the amplifier, by using an antiphase signal of the coded signal.

### CROSS-REFERENCE TO RELATED APPLICATION

This application claims priority to and the benefit of Korean Patent Application No. 10-2013-0108577 filed in the Korean Intellectual Property Office on Sep. 10, 2013, the entire contents of which are incorporated herein by reference.

### BACKGROUND OF THE INVENTION

(a) Field of the Invention

The present invention relates to an apparatus for a parallel readout of a touch screen.

(b) Description of the Related Art

Recently, touch screen applications such as smart phones and tablet PCs have increased, and as a result, controller integrated circuits (ICs) for touch screens have been rapidly developed. In addition, mutual capacitance type of touch screens which may recognize multi-touches have been widely used.

However, as a size of a display is increased, problems on a touch screen panel and a controller IC occur. One of the most important problems is that a load applied to a touch screen system is increased.

Meanwhile, in a touch screen application, a round-robin type is generally used. However, recently, for improvement of a signal-to-noise ratio (SNR) and a frame rate, parallel driving modes have been frequently used.

However, in the parallel driving mode, an overcurrent may be generated in a receiving terminal, and a dynamic range of an output voltage of the receiving terminal may be limited.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus of a parallel readout of a touch screen that may prevent an overcurrent phenomenon of a receiving terminal and extend a dynamic range of an output voltage of the receiving terminal.

An exemplary embodiment of the present invention provides a touch screen apparatus. The touch screen apparatus includes: a plurality of transmission channels to which a plurality of coded signals are input; a touch screen panel configured to convert the plurality of coded signals to a plurality of sensing currents according to a touch input of a user; an amplifier configured to amplify at least one current among the plurality of sensing currents to generate an output voltage; and a current subtraction circuit configured to generate a second current having an opposite phase to that of a first current among the sensing currents in a node where the touch screen panel is connected with the amplifier, by using an antiphase signal of the coded signal.

The touch screen panel may include a plurality of mutual capacitors of which the size is changed according to the touch input of the user and one end of two ends is connected to each of the plurality of transmission channels, and a first reception line which is connected with the other end of the two ends of the plurality of mutual capacitors and in which the first current flows.

The amplifier may include an amplifier that receives a sum of the first current and the second current by an inversion node through the first reception line, receives a reference voltage by a non-inversion node, and generates an output voltage by using a feedback circuit.

The current subtraction circuit may include an antiphase signal input unit to which the antiphase signal is input, and a plurality of variable capacitors which are controlled with the same size as the plurality of mutual capacitors. The current subtraction circuit may minimize the output voltage by using the antiphase signal and the plurality of variable capacitors.

The current subtraction circuit may minimize the sum of the first current and the second current by using the antiphase signal and the plurality of variable capacitors.

Another exemplary embodiment of the present invention provides a readout apparatus of a touch screen. The readout apparatus of the touch screen includes: an amplifier configured to amplify at least one current among the plurality of sensing currents generated according to a touch input for a touch screen panel of a user to generate an output voltage; and a current subtraction circuit configured to generate a second current having an opposite phase to that of a first current among the sensing currents in a node of the amplifier, by using an antiphase signal of the coded signal input to the touch screen.

The amplifier may include an amplifier that receives the sum of the first current and the second current by an inversion node, receives a reference voltage by a non-inversion node, and generates an output voltage by using a feedback circuit.

The current subtraction circuit may include an antiphase signal input unit to which the antiphase signal is input, and a plurality of variable capacitors which are controlled with the same size as the plurality of mutual capacitors included in the touch screen panel.

The current subtraction circuit may minimize the output voltage by using the antiphase signal and the plurality of variable capacitors.

The current subtraction circuit may minimize the output voltage by using the antiphase signal and the plurality of variable capacitors.

### BRIEF DESCRIPTION OF THE DRAWINGS

FIG. 1 is a diagram illustrating a touch screen application of a parallel driving type.

FIG. 2 is a diagram illustrating a part of a CDMS readout circuit.

FIG. 3 is a diagram illustrating a touch screen application with a current subtraction circuit added according to an exemplary embodiment of the present invention.

FIG. 4 is a diagram illustrating a part of the CDMS readout circuit with the current subtraction circuit added according to the exemplary embodiment of the present invention.

FIG. 5 is a graph of comparing an output voltage of the readout circuit to which the current subtraction circuit is applied according to the exemplary embodiment of the present invention with an output voltage of a readout circuit in the related art.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements. In addition, the terms “-er”, “-or”, “module”, and “block” described in the specification mean units for processing at least one function and operation, and can be implemented by hardware components or software components and combinations thereof.

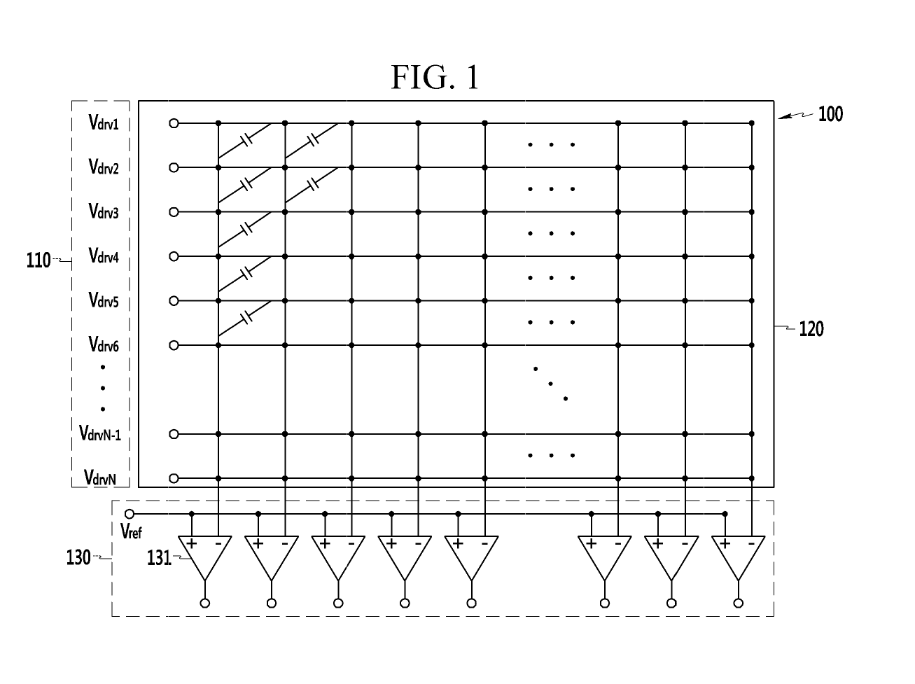

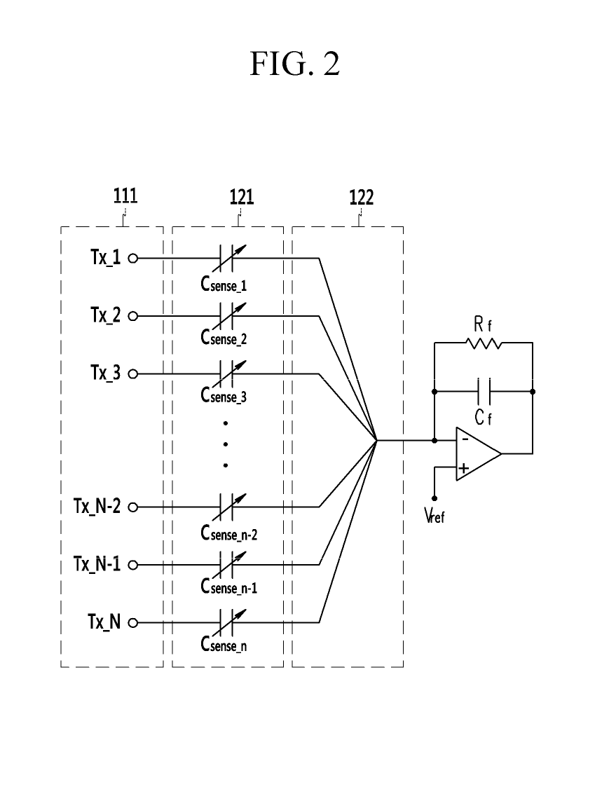

FIG. 1 is a diagram illustrating a touch screen application of a parallel driving type, and FIG. 2 is a diagram illustrating a part of a CDMS readout circuit.

Referring to FIG. 1, a touch screen application 100 according to the exemplary embodiment of the present invention includes a signal input unit 110, a touch screen panel 120, and a charge amplifier 130.

The signal input unit 110 includes a plurality of transmission Tₓ channels, and a coded signal is input to each channel. That is, coded signals are simultaneously input to the plurality of transmission channels in a code division multiple sensing (CDMS) readout circuit.

The touch screen panel 120 includes a mutual capacitor sensing a touch input of a user. In addition, in the touch screen panel 120, a plurality of transmission channels and a plurality of reception Rₓ lines cross each other with mutual capacitors therebetween. That is, when the user gives the touch input on the touch screen, a mutual capacitance Cₛₑₙₛₑ is changed. Thereafter, the coded signal input to the signal input unit is converted to a sensing current in proportion to the changed mutual capacitance, and the sensing current is transferred to a charge amplifier through the reception line.

The charge amplifier 130 includes a plurality of operation amplifiers in which the reception lines are connected to an inversion node and a reference voltage is connected to a non-inversion node. Each operation amplifier 131 (hereinafter referred to as a “charge amplifier”) included in the charge amplifier 130 amplifies a change amount of the mutual capacitance to generate an output voltage.

FIG. 2 illustrates one charge amplifier 131 among the plurality of charge amplifiers included in the charge amplifier 130, a plurality of transmission channels 111, a plurality of mutual capacitors 121, and one reception line 122. Further, in FIG. 2, the reception line 122 is connected to the inversion node of the charge amplifier 131, the reference voltage is connected to the non-inversion node, and a feedback circuit is connected between the inversion node and the output terminal. In the feedback circuit of FIG. 2, one resistor and one capacitor are connected to each other in parallel.

The plurality of coded signals input to the transmission channel are converted into the current in each mutual capacitor 121, and the converted current is input to the inversion node of the charge amplifier 131 along the reception line 122. In this case, the sum of the currents flowing in the reception lines 122 may be calculated as in Equation 1.

Iₜₒₜₐₗ=s(C₁V₁+C₂V₂+ . . . +C_{N}V_{N}) (Equation 1)

That is, the converted currents are combined in the inversion node of the charge amplifier 131, and form the output voltage through the feedback circuit. The output voltage may be calculated as in Equation 2.

$$\begin{matrix}{V}_{out \_ Max} = {I}_{total} \times \frac{{R}_{f}}{1 + {sR}_{f} {C}_{f}} \\ = s ( {C}_{1} {V}_{dd} + {C}_{1} {V}_{dd} + … + {C}_{1} {V}_{dd} ) \times \\ \frac{{R}_{f}}{1 + {sR}_{f} {C}_{f}} ( {sR}_{f} {C}_{f} > > 1 ) \\ ≅ \frac{{C}_{1} + {C}_{1} + … + {C}_{1}}{{C}_{f}} {V}_{dd}\end{matrix} \qquad ( Equation 2 )$$

In this case, since the coded signals are simultaneously input to the plurality of transmission channels in the CDMS readout circuit, the overcurrent may be generated in the inversion node of the charge amplifier 131. Further, it is difficult to sufficiently ensure the dynamic range due to the overcurrent.

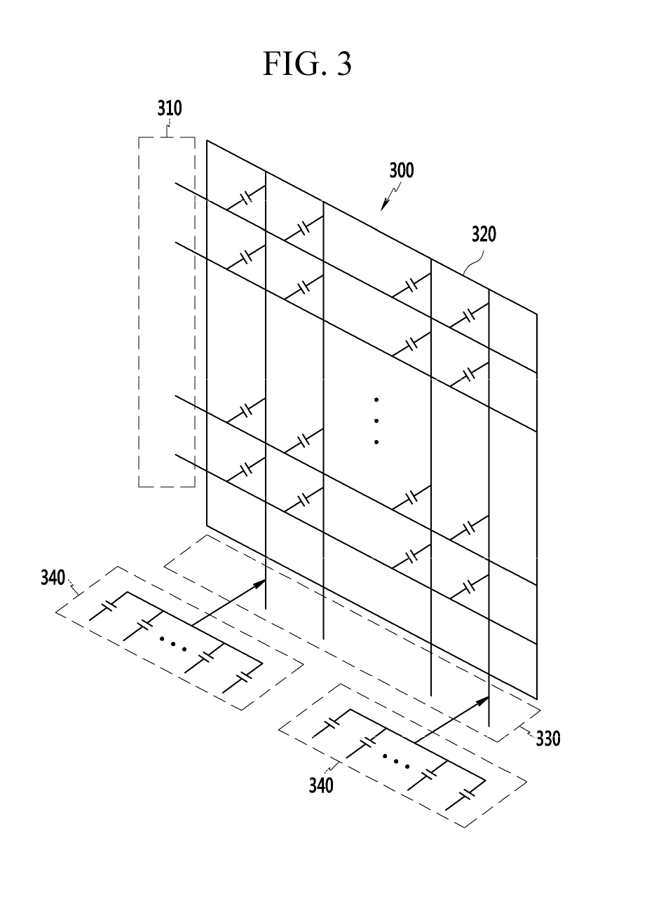

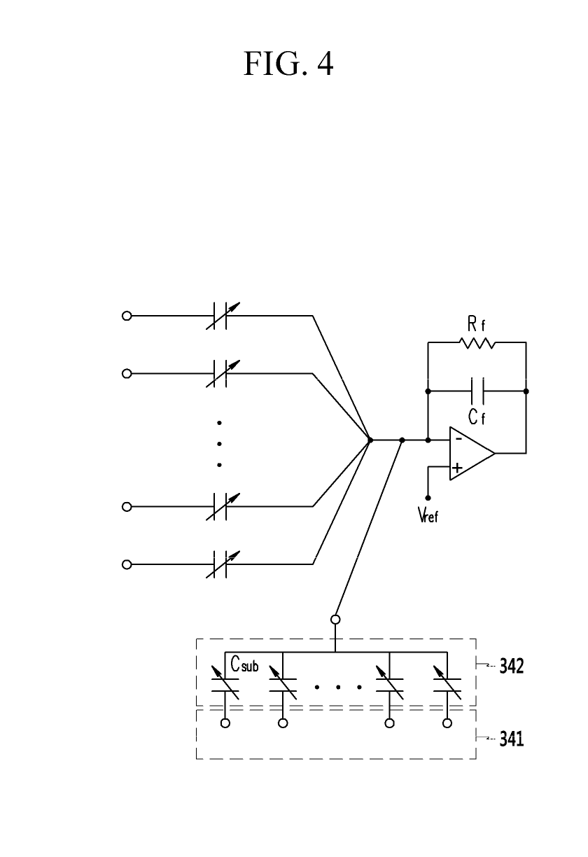

FIG. 3 is a diagram illustrating a touch screen application with a current subtraction circuit added according to an exemplary embodiment of the present invention, and FIG. 4 is a diagram illustrating a part of the CDMS readout circuit with the current subtraction circuit added according to the exemplary embodiment of the present invention.

In the exemplary embodiment of the present invention, pseudo noise (PN) codes which are perpendicular to each other may be applied to the plurality of coded signals input to several channels of the transmission terminal. A high value of the PN code may be expressed by an equiphase sine signal, and a low value may be expressed by an antiphase sine signal.

Referring to FIG. 3, the touch screen application 300 according to the exemplary embodiment of the present invention further includes a current subtraction circuit 340 in addition to a signal input unit 310, a touch screen panel 320, and a charge amplifier 330.

The current subtraction circuit 340 according to the exemplary embodiment of the present invention is connected to each inversion node of the charge amplifier 330. The current subtraction circuit 340 applies an antiphase voltage signal to a plurality of variable capacitors, and the current flowing in the inversion node of the charge amplifier may be discharged through the variable capacitor. That is, even though the coded signals input to the plurality of channels simultaneously enter the inversion node of the charge amplifier 330, the current subtraction circuit 340 generates a current having an antiphase in the inversion node by using the antiphase voltage signal to minimize the output voltage of the charge amplifier 330 while there is no touch input.

According to the exemplary embodiment of the present invention, the capacitance of the variable capacitor included in the current subtraction circuit 340 may be changed by up to 0 to 2 pF, and may be controlled according to the mutual capacitance included in the touch screen panel 320. In the exemplary embodiment of the present invention, when the capacitance of the mutual capacitor used in the touch screen panel 320 is 1.2 pF, the capacitance of the variable capacitor included in the current subtraction circuit 340 is 1.2 pF. That is, when the touch screen panel 320 is produced, the output voltage of the charge amplifier 330 may not be generated while there is no touch input by controlling the variable capacitor according to the capacitance of the mutual capacitor.

Referring to FIG. 4, the current subtraction circuit 340 of the CDMS readout circuit includes an antiphase signal input unit 341 and a plurality of variable capacitors 342.

In the antiphase signal input unit 341, an antiphase signal of the coded signal is input.

The plurality of variable capacitors 342 may be controlled according to the capacitance of the plurality of mutual capacitors included in the touch screen panel.

The current subtraction circuit 340 connected with the inversion node of the charge amplifier 330 may absorb the current flowing in the inversion node through the antiphase signal when there is no touch input. That is, according to the exemplary embodiment of the present invention, the current of the inversion node flowing in the feedback circuit is minimized due to the antiphase voltage signal, and accordingly, when there is no touch input, the output voltage of the charge amplifier may be minimized.

Equation 3 illustrates an output voltage when the current subtraction circuit 340 is connected to the inversion node of the charge amplifier 330.

$$\begin{matrix}{V}_{out} = I \times {Z}_{f} \\ = {\sum }_{k = 1}^{N} ( {sC}_{s \_ k} {V}_{Tx \_ k} + {sC}_{sub} {V}_{Tx \_ k}^{′} ) \times {Z}_{f} \\ = {\sum }_{k = 1}^{N} ( {sC}_{s \_ k} {V}_{Tx \_ k} + {sC}_{sub} {V}_{Tx \_ k}^{′} ) \times \frac{{R}_{f} / {sC}_{f}}{{R}_{f} + 1 / {sC}_{f}} \\ = \frac{{R}_{f}}{1 + {sR}_{f} {C}_{f}} {\sum }_{k = 1}^{N} ( {sC}_{s \_ k} {V}_{Tx \_ k} + {sC}_{sub} {V}_{Tx \_ k}^{′} ) \\ = \frac{{\sum }_{k = 1}^{N} ( {C}_{s \_ k} {V}_{Tx \_ k} + {C}_{sub} {V}_{Tx \_ k}^{′} )}{{C}_{f}} ( ∵ {sR}_{f} {C}_{f} > > 1 )\end{matrix} \qquad ( Equation 3 )$$

Referring to Equation 3, it can be seen that when a numerator Cₛ_{_{—}}ₖV_{Tx}_{_{—}}ₖV′_{Tx}_{_{—}}ₖ is 0, the output voltage is 0. That is, in the current subtraction circuit 340, the numerator of Equation 3 may be minimized by using the antiphase signal of the coded signal. In the exemplary embodiment of the present invention, the current flowing in the reception line may be maximally discharged toward the antiphase signal input unit 341 by controlling the plurality of variable capacitors 342 included in the current subtraction circuit 340 and using the antiphase signal of the coded signal.

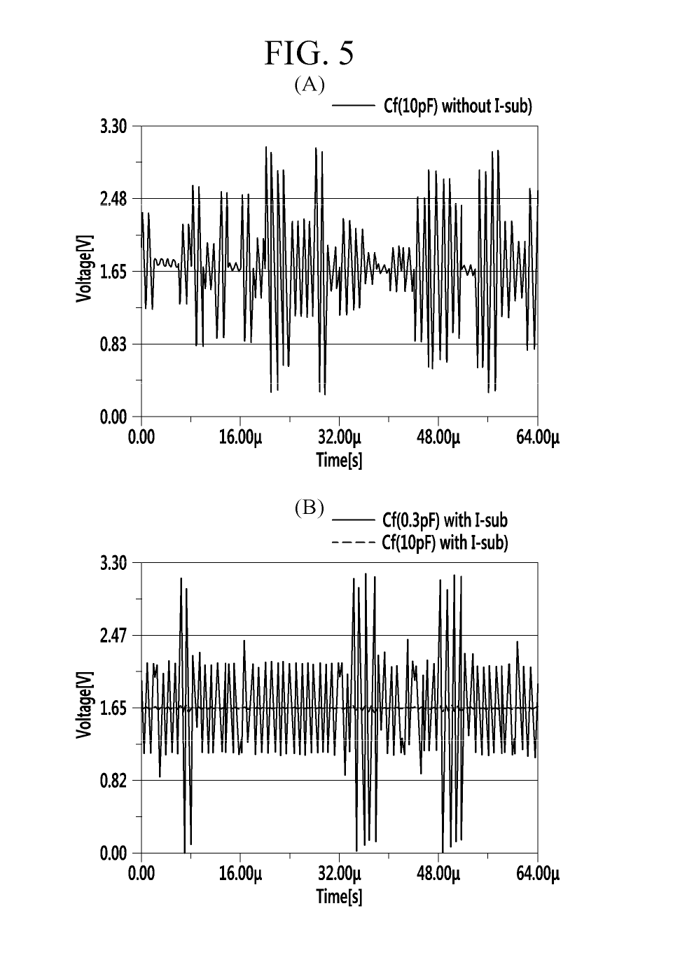

FIG. 5 is a graph comparing an output voltage of the readout circuit to which the current subtraction circuit is applied according to the exemplary embodiment of the present invention with an output voltage of a readout circuit in the related art.

FIG. 5 illustrates an output voltage measured with time in the case of a mutual capacitance of 1.1 pF to 1.2 pF, 32 transmission channels, 24 reception lines, a feedback capacitor C_{f} of 10 pF, and a supply voltage V_{dd} of 3.3 V.

FIG. 5 (A) is a graph illustrating an output voltage of a readout circuit in the related art. FIG. 5 (A) illustrates that the output voltage is very variable between 0 and V_{dd}.

FIG. 5 (B) is a graph illustrating an output voltage of the readout circuit to which the current subtraction circuit is applied. In FIG. 5 (B), when the feedback capacitor is 10 pF, the output voltage is almost not changed at 1.65 V, unlike the case where the feedback capacitor is 0.3 pF. That is, a dynamic range of the output voltage is 0.09 V at 1.61 V to 1.70 V. Referring to Equation 3, this is because a magnitude of the output voltage is decreased when the capacitance of the feedback capacitor positioned at a denominator in a transfer function of the output voltage is increased.

When the feedback capacitor is 0.3 pF, the output voltage is stably maintained at 1.235 V to 2.06 V, and then sometimes represents a large amplitude of 0.05 V to 3.10 V. This is determined as the reason why the touch input is sensed. That is, the magnitude of the feedback capacitance may be reduced by applying the current subtraction circuit, and the dynamic range of the output voltage is extended. In the exemplary embodiment of the present invention, the dynamic range of the output voltage is increased to 31 dB (0.09 ->3.05).

As described above, according to the exemplary embodiment of the present invention, it is possible to prevent the overcurrent of the amplification terminal and largely extend the dynamic range of the output voltage, by applying a current subtraction method to the CDMS type readout circuit.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A touch screen apparatus, comprising:
a plurality of transmission channels to which a plurality of coded signals are input;
a touch screen panel configured to convert the plurality of coded signals to a plurality of sensing currents according to a touch input of a user;
an amplifier configured to amplify at least one current among the plurality of sensing currents to generate an output voltage; and
a current subtraction circuit configured to generate a second current having an opposite phase to that of a first current among the sensing currents in a node where the touch screen panel is connected with the amplifier, by using an antiphase signal of the coded signal.

2. The touch screen apparatus of claim 1, wherein
the touch screen panel includes
a plurality of mutual capacitors of which the size is changed according to the touch input of the user and one end of two ends is connected to each of the plurality of transmission channels, and
a first reception line which is connected with the other end of the two ends of the plurality of mutual capacitors and in which the first current flows.

3. The touch screen apparatus of claim 2, wherein
the amplifier includes
an amplifier that receives the sum of the first current and the second current by an inversion node through the first reception line, receives a reference voltage by a non-inversion node, and generates an output voltage by using a feedback circuit.

4. The touch screen apparatus of claim 3, wherein
the current subtraction circuit includes
an antiphase signal input unit to which the antiphase signal is input, and
a plurality of variable capacitors which are controlled with the same size as the plurality of mutual capacitors.

5. The touch screen apparatus of claim 4, wherein
the current subtraction circuit
minimizes the output voltage by using the antiphase signal and the plurality of variable capacitors.

6. The touch screen apparatus of claim 4, wherein
the current subtraction circuit
minimizes the sum of the first current and the second current by using the antiphase signal and the plurality of variable capacitors.

7. A readout apparatus of a touch screen, comprising:
an amplifier configured to amplify at least one current among the plurality of sensing currents generated according to a touch input for a touch screen panel of a user to generate an output voltage; and
a current subtraction circuit configured to generate a second current having an opposite phase to that of a first current among the sensing currents in a node of the amplifier, by using an antiphase signal of the coded signal input to the touch screen.

8. The readout apparatus of claim 7, wherein
the amplifier includes
an amplifier that receives a sum of the first current and the second current by an inversion node, receives a reference voltage by a non-inversion node, and generates an output voltage by using a feedback circuit.

9. The readout apparatus of claim 8, wherein
the current subtraction circuit includes
an antiphase signal input unit to which the antiphase signal is input, and
a plurality of variable capacitors which are controlled with the same size as the plurality of mutual capacitors included in the touch screen panel.

10. The readout apparatus of claim 9, wherein
the current subtraction circuit
minimizes the output voltage by using the antiphase signal and the plurality of variable capacitors.

11. The readout apparatus of claim 9, wherein
the current subtraction circuit
minimizes the output voltage by using the antiphase signal and the plurality of variable capacitors.
